(19) United States
(12) Patent Application Publication
(10) Pub. No.: US 2003/0212881 A1
(43) Pub. Date: Nov. 13, 2003

(54) Method and apparatus to enhance performance in a multi-threaded microprocessor with predication

(76) Inventors: Udo Walterscheidt, San Jose, CA (US); James S. Burns, Cupertino, CA (US)

Correspondence Address: Dennis A. Nicholls, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/141,546

(22) Filed: May 7, 2002

(51) Int. Cl. G06F 9/00

(52) U.S. Cl. 712/226

(57) ABSTRACT

A method and apparatus for a processor is described. In one embodiment, in a processor capable of executing multiple instructions simultaneously, simplified execution units are utilized that execute those instructions which are predicated-off. Dispersal logic is described that maps predicated-off instructions to these simplified execution units at appropriate times in order to enhance system performance.

### FIELD OF THE INVENTION

The present invention relates generally to microprocessors, and more specifically to microprocessors that utilize predication for branch operations.

### BACKGROUND OF THE INVENTION

A multi-threaded microprocessor is one in which several program elements, or “threads”, may be processed either near in time or simultaneously. Multi-threaded microprocessors may accomplish this by sharing some of the program execution environment between the threads so that little state information needs to be saved and then restored when changing from one thread to another.

A simultaneous multi-threaded (SMT) microprocessor allows the threads to execute simultaneously by supplying instructions from several threads to multiple execution units per clock cycle. Two or more distinct software threads may make use of available processor resources simultaneously. When one thread cannot continue when, for example, outstanding data returns are expected from external memory, the other threads may continue to execute. This avoids the otherwise inevitable idle cycles in the processor. Another aspect is that execution resources that are not occupied by one thread may be made available to the other threads.

A particularly troublesome problem encountered in wide and deep pipelined systems, including simultaneous multi-threaded microprocessors, is that of branching. Branching occurs when program flow follows one of two directions depending upon the determination of a conditional operation. This is most familiar to programmers in the form of an if/then/else sequence of instructions. If executed as written, the pipeline must be stalled until the resolution of the “if” conditional operation.

One approach to prevent stalling the pipeline is called prediction. In prediction, the most likely outcome of the conditional operation is determined, and the subsequent operations in the corresponding direction of the branch are scheduled for execution prior to the actual determination of the outcome of the conditional operation. If the actual outcome matches the predicted outcome, then all is well and no time has been lost. If, on the other hand, the actual outcome does not match the predicted outcome, then the pipeline must be flushed and the instructions corresponding to the non-predicted branch loaded. This may represent a large loss of system performance. Even with modern prediction methods that achieve 90% correct prediction rates, the remaining incorrect predictions may cause poor system performance.

Therefore, another method to prevent stalling the pipeline, called predication, has been developed. Predication associates a logical variable, called a predicate, with each instruction. If the predicate value is true, then the instruction updates state. Otherwise the instruction generally behaves like a no-operation (nop). Predicate values may be assigned by predicate-producing instructions, such as, for example, compare instructions.

Predicated execution eliminates branches by converting them into a pair of predicated sets of instructions. As an example, consider the branch

if (a>b)c=c+1

else d=d*e+f

This may be converted to predicated code using the predicate variables pT, and its compliment pF, as follows

pT, pF=compare (a>b)

if (pT)c=c+1

if (pF)d=d*e+f

The predicate variable pT is set to 1 if the condition evaluates to true, and to 0 if the condition evaluates to false.

Now the compiler may schedule the instructions under pT and pF to execute in parallel, essentially allowing both directions of the branch to be loaded into the pipeline. When the condition is finally evaluated, the appropriate predicate values will be inserted into pT and pF. The instructions with a predicate value of 1 will execute normally. The instructions with a predicate value of 0, called “predicated-off” instructions, will not execute normally. Instead the predicated-off instructions will generally act as nop instructions, only performing minimal housekeeping functions such as updating the instruction pointer.

In this manner, predication prevents either stalling or flushing the pipeline, helping to improve system performance. However, even though an instruction that is predicated-off does not change architectural state, it still occupies execution resources. In a multi-threaded environment, the resources occupied by predicated-off instructions could have been utilized by another thread, thus improving throughput.

### DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of the instruction processing section of a microprocessor.

FIG. 2 is a diagram of an exemplary mapping of instruction elements of two threads in the microprocessor of FIG. 1.

FIG. 3 is a schematic diagram of the instruction processing section of a microprocessor, in accordance with one embodiment of the present invention.

FIG. 4 is a diagram of an exemplary mapping of instruction elements of two threads in the microprocessor of FIG. 3, according to one embodiment of the present invention.

FIG. 5 is a flowchart of the mapping of instructions of FIG. 3, according to one embodiment of the present invention.

FIG. 6 is a flowchart of the mapping of instructions of FIG. 3, according to another embodiment of the present invention.

### DETAILED DESCRIPTION

The following description describes techniques for a processor utilizing predication. In the following description, numerous specific details such as logic implementations and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of a microprocessor. However, the invention may be practiced in other forms of processor such as a digital signal processor, a minicomputer, or a mainframe computer.

In one exemplary embodiment, functional units described below may correspond generally with stages within an instruction pipeline. In one embodiment, these stages may correspond to the prefetch (IPG), fetch (FET), instruction rotation (ROT), expand (EXP), register rename (REN), wordline decode (WLD), register read (REG), instruction execution (EXE), exception detection (DET), and finally writeback (WRB) in an Intel® Itanium™ processor. These stages are described in the Intel® Itanium™ Processor Hardware Developer's Manual, August 2001, document number 248701-002. (Available at the time of filing of the present disclosure at http://developer.intel.com/design/itanium/manuals.htm.)

From the background section it may be recalled that even though a predicated-off instruction does not change architectural state, it still occupies execution resources. In a multi-threaded environment, the resources occupied by predicated-off instructions could have been utilized by another thread, thus improving throughput. Therefore, in one embodiment of the present invention, additional simplified execution units are utilized that allow for the processing of the predicated-off instructions without requiring the use of substantive execution units. Logic is described in the dispersal logic circuitry that may switch predicated-off instructions to these simplified execution units. In this manner, predicated-off instructions are dealt with without either consuming present execution resources or adding additional substantive execution resources.

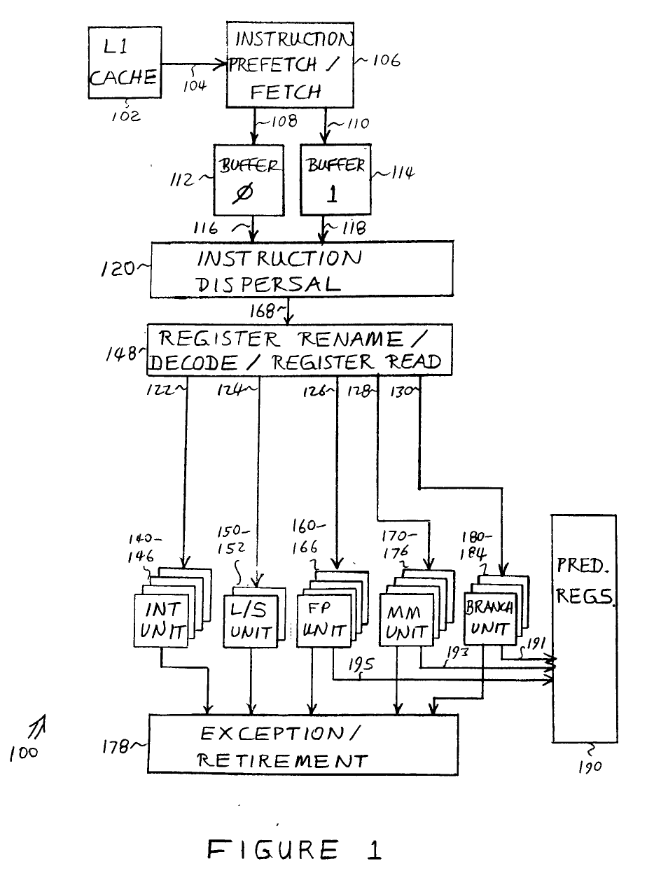

Referring now to FIG. 1, a schematic diagram of the instruction processing section 100 of a microprocessor is shown. Level-one (L1). cache 102 stores instructions that may be fetched by the instruction prefetch/fetch circuit 106. Instruction prefetch/fetch circuit 106 may in one embodiment include prefetch (IPG) and fetch (FET) circuits in a pipeline. The instructions for individual threads may then be organized in one or more instruction buffers, such as instruction buffer 0 112 and instruction buffer 1 114 shown. In alternate embodiments, more than two instruction buffers may be used. In one embodiment each entry in the instruction buffers may contain multiple instructions organized as one or more “bundles”, where each bundle is a set of three instructions of specified types. Instruction buffers 112, 114 may in one embodiment include instruction rotation (ROT) circuits for determining handling of bundles in a pipeline.

The centerpiece of instruction processing section 100 is a set of execution units. In one embodiment, there are sets of specialized execution units, including 4 integer units 140-146, 2 load/store units 150-152, 4 floating point units 160-166, 4 multimedia units 170-176, and 3 branch units 180-184. In one embodiment, these execution units may include execute (EXE) circuits for execution of instructions in a pipeline. In alternate embodiments, the execution units may vary in type and quantity, and in some embodiments may be all of a similar type. The branch units 180-184 may execute branching instructions, in other words instructions that may change execution flow. Some or all execution units may execute predicate-generating instructions that may write logical values into one or more of a set of predicate registers. In one embodiment there are 64 1-bit, predicate registers, named PR0 through PR63, in the set of predicate registers 190. Exemplary paths 191, 193, and 195 permit exemplary execution units to write to members of the set of predicate registers 190.

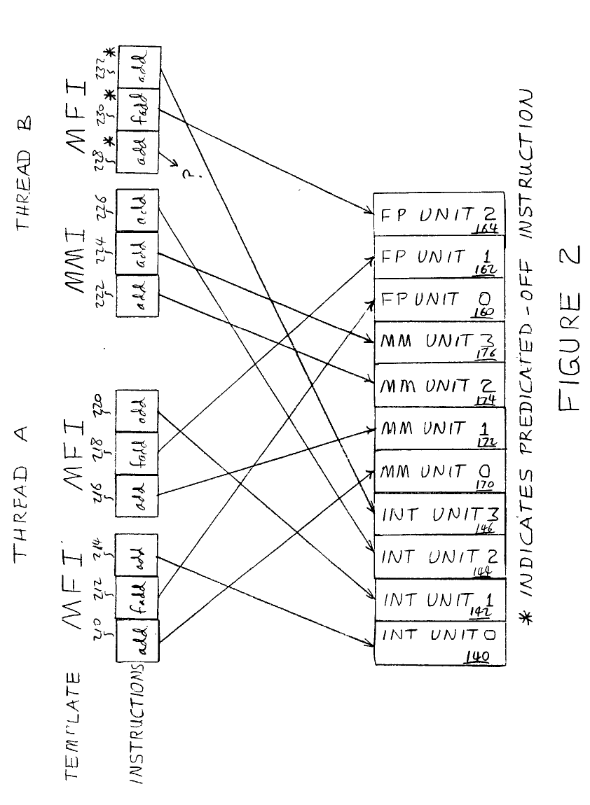

Since instruction buffer 0 112 and instruction buffer 1 114 may each contain multiple instructions presented at given points in time, instruction dispersal 120 may map instructions to individual execution units by execution unit type and number. In one embodiment, instruction dispersal 120 may include execution units (EXE) in a pipeline. Details of the mapping are shown in detail in the discussion of FIG. 2 below.

After individual instructions are dispersed by instruction dispersal 120, several additional functions must be performed prior to actual execution of the instructions. These functions may be performed by a register rename/decode/register read block 148. This block may, among other functions, map virtual register names in an instruction to physical registers in the processor. The registers renamed may include general purpose registers and floating-point registers, but also may include the predicate registers. In one embodiment, register rename/decode/register read block 148 may include the register rename (REN), wordline decode (WLD), and register read (REG) units in a pipeline.

Forming the path that instructions pass through between the buffers 112, 114 and the execution units, instruction dispersal 120 and register rename/decode/register read block 148 may be generally referred to collectively as dispersal logic.

By writing values to the set of predicate registers 190, various execution units may ensure that the appropriate future instructions within instruction buffer 0 112 and instruction buffer 1 114 are predicated-off.

In processors that utilize register renaming, it is generally not possible to map the predicate information kept in the elements of the set of predicate registers 190 to entries in the instruction buffers 112, 114. This is because each instruction in those buffers may be tagged with a virtual predicate register that is not at that moment in known correspondence with a physical predicate register within the set of predicate registers 190. Only after the register renaming process, that may be performed in register rename/decode/register read block 148, may the exact mapping be known, and an assignment of qualifying predicate performed. Since dispersed instructions are needed for the renaming process, an instruction will generally be targeted to a particular execution unit before it can be determined whether or not its physical qualifying predicate register contains a “0” or a “1”, e.g. whether the instruction is predicated off or on.

Therefore, even when a particular instruction is predicated-off it still is mapped by the instruction dispersal 120 to an execution unit. A predicated-off instruction is treated as a nop by an execution unit, and only updates certain housekeeping functions. But even though a predicated-off instruction may be treated as a nop, it still occupies the resources of the execution unit during execution.

Referring now to FIG. 2, a diagram of an exemplary mapping of instruction elements of two threads in the microprocessor of FIG. 1 is shown. In the FIG. 2 example, threads A and B may each contain two bundles worth of instructions at any given time. Here the first bundle of thread A, of format MFI, contains a multi-media add 210, a floating-point add 212, and an integer add 214. Instruction dispersal 120 may map the multi-media add 210 to multimedia unit 0 170, the floating-point add 212 to floating-point unit 0 160, and integer add 214 to integer unit 0 140.

An example of a situation that may arise with predicated-off instructions occurs in the second bundle of thread B, including 3 predicated-off instructions. Here sufficient processor resources exist to allow the mapping of predicated-off floating-point add 230 to floating-point unit 2 164 and of predicated-off integer add 232 to integer unit 3 146. However, predicated-off multi-media add 228 cannot be mapped to a multi-media unit for the upcoming cycle since all the multi-media units are mapped to other multi-media instructions. This architecture supports the use of a subsequent cycle to process multi-media add 228, lowering system performance. The fact that the predicated-off multi-media add 228 performs no useful function does not permit it to avoid requiring system resources in the FIG. 1 architecture.

In the following discussions, instructions may be referred to as either having or not having a predicate register associated with them. In one embodiment, the expression “an instruction not having a predicate register associated with it” should be interpreted to mean that the instruction has no non-trivial or non-default predicate register associated with it. In this embodiment, all instructions automatically come with a 6-bit field containing the binary number of the associated predicate register. When the field is not used, it contains by default all zeros and therefore associates the instruction with PR0. However, the value of this default register PR0 is always 1 (true). Such an instruction behaves as if it was not really predicated because the instruction always executes. Hence in these embodiments the expression “the instruction has a predicate register associated with it” should be read as literally meaning “the instruction has a non-trivial (e.g. non-default) predicate register associated with it”: the expression “the instruction has no predicate register associated with it” should be read as literally meaning “the instruction has no non-trivial (e.g. non-default) predicate register associated with it.”

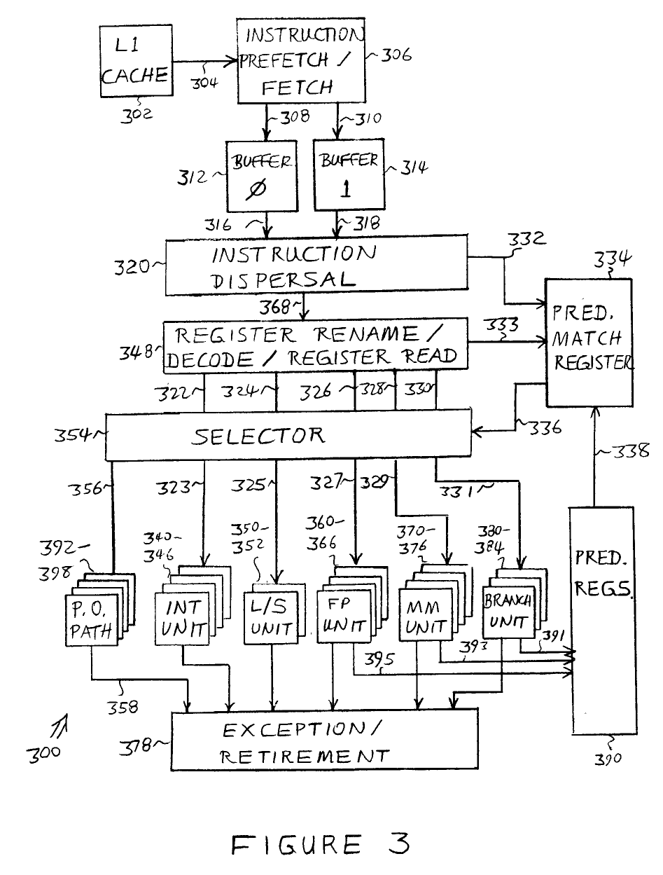

Referring now to FIG. 3, a schematic diagram of the instruction processing section 300 of a microprocessor is shown, in accordance with one embodiment of the present invention. Many of the functional units of the instruction processing section 300 of FIG. 3 may perform similar tasks when compared with the instruction processing section 100 of FIG. 1. However, instruction processing section 300 includes a number of predicated-off paths 392-398. Each of the predicated-off paths 392-398 may be a simplified execution unit, and may include little more than some pass-through circuitry and processor housekeeping circuitry. These simple predicated-off paths 392-398 may occupy greatly reduced die area and consume reduced power when compared with the other execution units that actually process substantive instructions.

In order to make use of the predicated-off paths 392-398, a predicate match register 334 and selector 354 may be utilized. The current values of each predicate register in the set of physical predicate registers 390 are presented to the predicate match register 334 for comparison or reference. The predicate match register 334 may be set up by instructions that executed at a previous time, either explicitly or implicitly as a byproduct of some other operation, to contain the number of a predicate register number that may neither change its number nor change its virtual-to-physical register mapping. At other times the predicate match register 334 may be set up by a prediction algorithm, rather than by an instruction. Such a prediction algorithm may be required to make the correct prediction if the outcome of the prediction is that the corresponding predicate register value is “0”. A relaxed requirement may be sufficient if the outcome of the prediction is that the corresponding predicate register value is “1”, since functional correctness will be maintained if the instruction is directed to a normal execution unit.

Subsequent to the mapping of instructions to execution units in instruction dispersal 320, and subsequent to any predicate register renaming within register rename/decode/register read block 354, the register rename/decode/register read block 354 may inspect all instructions passing through it for physical predicate registers associated with each instruction. For those instructions that now have physical qualifying predicate registers associated, the identification of the predicate register associated with each instruction is signaled to the predicate match register 334 via a predicate identification signal 333. For each identified associated predicate register, the value of that predicate register is checked to see if it is 0 (false), indicating that the associated instruction will be predicated-off. If so, then the predicate match register 334 signals the selector 354 via a selector switch signal 336, causing the appropriate instruction coming from register rename/decode/register read block 348 to be sent one of the predicated-off path 392-398 simplified execution units. If there is no associated predicate register, or if the predicted or speculated value of an associated predicate register will be 1 (true), then the selector merely passes instructions on to the execution units previously mapped by the instruction dispersal 320.

Making a similar definition as was made in connection with FIG. 1 above, instruction dispersal 120, register rename/decode/register read block 148, predicate match register 334, and selector 354 may be generally referred to collectively as dispersal logic.

As a first example, consider a first integer instruction that is not predicated at all. In other words, the first integer instruction has no predicate register associated with it. Instruction dispersal 354 would not signal any associated predicate register for the first integer instruction to the predicate match register 334 via a predicate identification signal 332. Therefore, predicate match register 334 would not signal the selector 354 via a selector switch signal 336 to switch the first integer instruction to one of the predicated-off paths 392-398. Instead, the first integer instruction would emerge from instruction dispersal 320 along normal path 322, pass through selector 354, and be conducted to one of the integer units 340-346 along normal path 323.

As a second example, consider a second integer instruction that is predicted or speculated to be not predicated-off, or that has been explicitly set by a previous instruction to be not predicated-off. In other words, the second integer instruction has a predicate register associated with it, for example virtual predicate register PR7, but the value of PR7 is “1” (true). Instruction dispersal 354 would signal the associated predicate register PR7 for the second integer instruction to the predicate match register 334 via a predicate identification signal 332. However, predicate match register 334 would anticipate that the value of PR7 will be “1” due to the prediction or speculation techniques used. Predicate match register 334, anticipating that the value of PR7 will be “1”, would not signal the selector 354 via a selector switch signal 336 to switch the second integer instruction to one of the predicated-off paths 392-398. Instead, the second integer instruction would emerge from register rename/decode/register read block 354 along normal path 322, pass through selector 354, and be conducted to one of the integer units 340-346 along normal path 323.

Finally, as a third example, consider a third integer instruction that is predicted or speculated to be predicated-off, or that has been explicitly set by a previous instruction to be predicated-off.. In other words, the third integer instruction has a predicate register associated with it, for example PR12, and the predicted or speculated value of PR12 is “0” (false). Register rename/decode/register read block 354 would signal the associated predicate register PR12 for the third integer instruction to the predicate match register 334 via a predicate identification signal 333. Since predicate match register 334 would anticipate that the value of PR12 will be “0”, due to, for example, the prediction or speculation techniques used, predicate match register 334 would anticipate that the third integer instruction will be predicated-off. Therefore predicate match register 334, anticipating that the current value of PR12 will be 0, would signal the selector 354 via a selector switch signal 336 to switch the third integer instruction to one of the predicated-off paths 392-398 along bypass path 356. By being routed to one of the predicated-off paths 392-396, the third integer instruction would not consume the resources of a substantive execution unit.

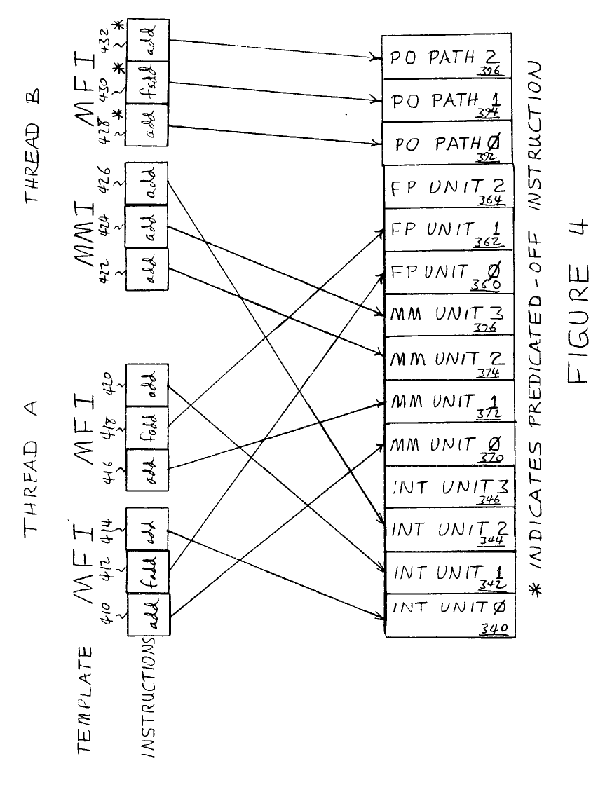

Referring now to FIG. 4, a diagram of an exemplary mapping of instruction elements of two threads in the microprocessor of FIG. 3 is shown, according to one embodiment of the present invention. In the FIG. 4 example, threads A and B may each contain two bundles worth of instructions at any given time. Here the exemplary bundles of thread A and thread B have the same kinds of instructions as used in the example of FIG. 2 above. Instruction dispersal 320 may map the multi-media add 410 to multimedia unit 0 370, the floating-point add 412 to floating-point unit 0 360, and integer add 414 to integer unit 0 340.

An example of a situation that may arise with instructions that are predicted or speculated to be predicated-off occurs in the second bundle of thread B, including 3 instructions predicted or speculated to be predicated-off instructions. When these predicted or speculated to be predicated-off instructions, multi-media add 428, floating-point add 430, and integer add 432, arrive at instruction dispersal 320, the status that they are predicated is conveyed to the predicate match register 334. The predicate match register 334 then compares the predicate registers of multi-media add 428, floating-point add 430, and integer add 432 to the predicted or speculated values of the corresponding predicate registers. In this example, all three instructions are anticipated to be predicated-off, and therefore have predicted or speculated predicate register values of 0 (false). After making this determination, predicate match register 334 may then signal the selector 354 via a selector switch signal 336 to switch each of multi-media add 428, floating-point add 430, and integer add 432 to one of the predicated-off paths 392-398 along bypass path 356. In the present example, multi-media add 428 is mapped to predicated-off path 392, floating-point add 430 is mapped to predicated-off path 394, and integer add 432 is mapped to predicated-off path 396. Sufficient system resources then exist to map all substantive instructions to substantive execution units.

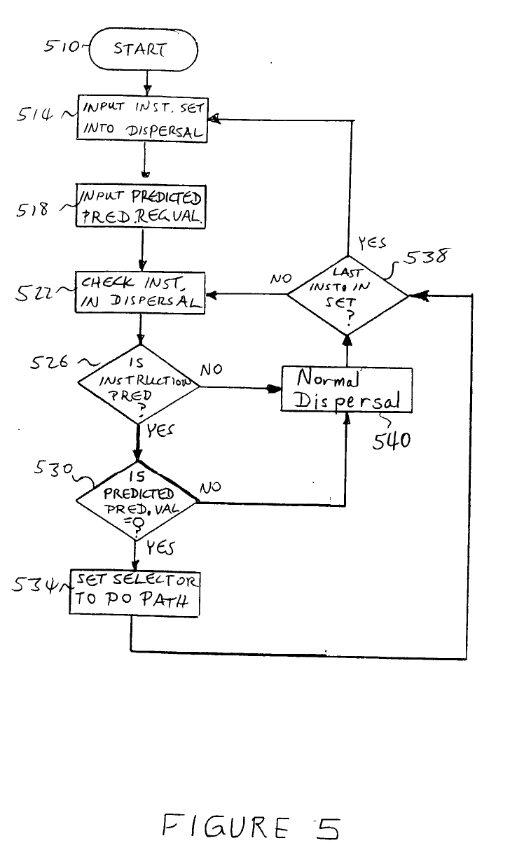

Referring now to FIG. 5, a flowchart of the mapping of instructions of FIG. 3 is shown, according to one embodiment of the present invention. In block 514, several bundles of instructions are advanced from buffer 0 312 and buffer 1 314 into instruction dispersal 320. Then in block 518 predicted or speculated values of the predicate registers are input into predicate match register 334. Each instruction contained in instruction dispersal 320 or in register rename/decode/register read block 354 may in turn be checked in block 522 to see if a particular instruction has been predicated, and, if so, what the predicted or speculated predicate value is for the corresponding predicate register. In decision block 526, if an instruction is not predicated at all, it is dispersed normally via block 540. Otherwise, in decision block 530, those predicated instructions that have predicted or speculated predicate register values of 1 (true) are likewise normally dispersed via block 540. (In this example, normally dispersed should be interpreted as being dispersed by instruction dispersal 320 to one of the substantive execution units.) Only those predicated instructions that have predicted or speculated predicate register values of 0 (false) are sent, in block 534, to one of the predicated-off paths 392-398.

After each instruction is mapped, in decision block 538 it is determined whether each instruction is the last in the current set of bundles. If so, block 514 repeats, and new sets of bundles are loaded. If not, then the next instruction in the current set of bundles is mapped.

The flowchart of FIG. 5 illustrates the process of one embodiment as a series of successive blocks. In other embodiments, portions of the process could occur simultaneously.

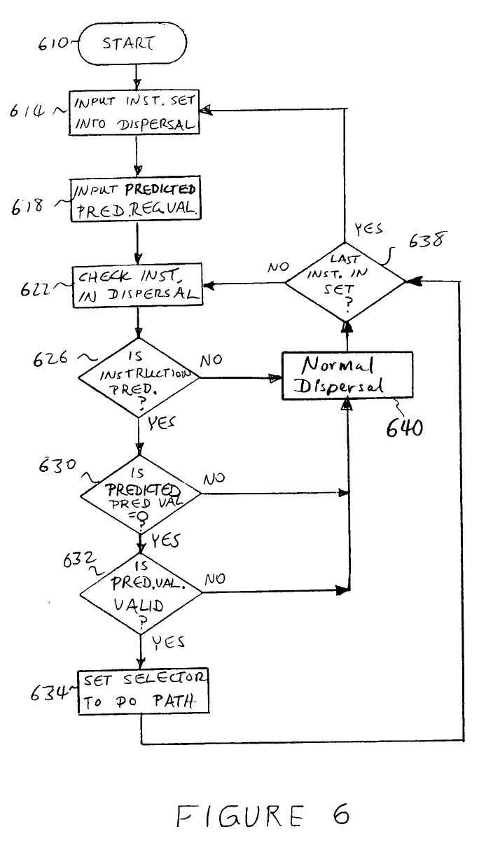

Referring now to FIG. 6, a flowchart of the mapping of instructions of FIG. 3 is shown, according to another embodiment of the present invention. The FIG. 6 process utilizes the technique of executing special “hint” instructions as a particular form of the prediction or speculation technique discussed generally in the FIG. 5 process.

In the FIG. 6 process, “hint” instructions are utilized. When the compiler converts branched instructions to predicated instructions, it inserts hint instructions into the code. Hint instructions are one form of explicit hints. In one embodiment, the explicit hint instructions make a promise that specified predicate register values will contain a particular value for the following N instructions. In alternate embodiments, the explicit hint instructions make a promise that the specified predicate register values will not change until countermanded by a subsequent “unhint” instruction. In either case, the hint instructions generally act as nop instructions, except that the promises that the predicate register values will have a particular, given value may be understood by the hardware, such as, in one embodiment, the predicate match register 334.

The FIG. 6 process generally operates in the manner of the FIG. 5 process. In decision block 630, the various elements of dispersal logic, including instruction dispersal 320 and predicate match register 334, utilize the information given by the hint instructions. By utilizing the predicted or speculated values of the predicate register given by the hint instruction, dispersal logic may, if the predicate register value is not 0, cause the instruction to be normally dispersed in block 640. If the predicate register is anticipated to be 0, then a following validity decision block 632 is entered.

In decision block 632, the dispersal logic may determine whether a particular predicate register value given by a hint instruction is valid with respect to a given instruction. In one embodiment, if the number of instructions N given by the hint instruction have not been exceeded, the value is determined to still be valid. In another embodiment, if the hint instruction has not been countermanded by a subsequent unhint instruction, the value is determined to be valid. If valid, then the process proceeds along the YES path to block 634, and the instruction is dispersed to a predicated-off path. If not valid, then the process proceeds along the NO path and the instruction is dispersed normally to a substantive execution unit. In other embodiments, the placement of a block corresponding to block 632 may precede either or both blocks 626 and 630.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
a simplified execution unit; and
a dispersal logic to map a predicated-off instruction to said simplified execution unit.

2. The apparatus of claim 1, wherein said simplified execution unit is a predicated-off path.

3. The apparatus of claim 2, wherein said predicted-off path includes pass-through circuitry and processor housekeeping circuitry.

4. The apparatus of claim 1, wherein said dispersal logic includes a predicate match register.

5. The apparatus of claim 4, wherein said predicate match register determines whether a first predicate register associated with a first instruction has a first value of true or false.

6. The apparatus of claim 5, wherein said predicate match register issues a first signal to said dispersal logic when said first value is false.

7. The apparatus of claim 6, wherein said dispersal logic couples said first instruction to said simplified execution unit responsively to said first signal.

8. The apparatus of claim 1, wherein said dispersal logic is responsive to a hint instruction.

9. The apparatus of claim 8, wherein said hint instruction informs when a predicate register value is valid.

10. A method, comprising:
checking a first instruction for a value of an associated predicate register;
normally mapping said first instruction to a substantive execution unit when said value is true; and
alternatively mapping said first instruction to a simplified execution unit when said value is false.

11. The method of claim 10, wherein said checking includes determining whether said first instruction is associated with a non-trivial predicate register.

12. The method of claim 10, wherein said alternate mapping includes switching said first instruction from a normal path to a predicated-off path.

13. The method of claim 10, further comprising issuing a hint instruction.

14. The method of claim 13, wherein said alternate mapping includes determining the validity of said value responsively to said hint instruction.

15. An apparatus, comprising:
means for checking a first instruction for a value of an associated predicate register;
means for normally mapping said first instruction to a substantive execution unit when said value is true; and
means for alternatively mapping said first instruction to a simplified execution unit when said value is false.

16. The apparatus of claim 15, wherein said means for checking includes means for determining whether said first instruction is associated with a non-trivial predicate register.

17. The apparatus of claim 15, wherein said means for alternate mapping includes means for switching said first instruction from a normal path to a predicated-off path.

18. The apparatus of claim 15, further comprising means for receiving a hint instruction.

19. The apparatus of claim 18, wherein said means for alternate mapping includes means for determining the validity of said value responsively to said hint instruction.

20. An apparatus, comprising:
a predicated-off path; and
a dispersal logic to map a predicated-off instruction to said predicated-off path.

21. The apparatus of claim 20, wherein said predicted-off path includes a simplified execution unit.
